(19) United States
(12) Patent Application Publication
(10) Pub. No.: US 2018/0373986 A1
(43) Pub. Date: Dec. 27, 2018

(54) MACHINE LEARNING USING DYNAMIC MULTILAYER PERCEPTRONS

(71) Applicant: QbitLogic, Inc., Atlanta, GA (US)

(72) Inventor: Blake Rainwater, Atlanta, GA (US)

(73) Assignee: QbitLogic, Inc., Atlanta, GA (US)

(21) Appl. No.: 15/982,635

(22) Filed: May 17, 2018

Related U.S. Application Data
(60) Provisional application No. 62/524,932, filed on Jun. 26, 2017.

(51) Int. Cl. G06N 3/08; G06N 3/04; G06N 99/00

(52) U.S. Cl. CPC G06N 3/084; G06N 99/005; G06N 3/0454

(57) ABSTRACT

A system and method for implementing a machine learning system using dynamic multilayer perceptrons transforms input data into directed acyclic graphs. Dynamic multilayer perceptron network graphs are generated based at least in part on the directed acyclic graphs. During training of the machine learning system, a trained weight set is determined by transforming training data into directed acyclic graphs and dynamic multilayer perceptron network graphs and adjusting the weights of the dynamic multilayer perceptron network graphs. When using the machine learning system, an output value is determined by transforming subject data into a subject dynamic acyclic graph. The trained weight set and subject dynamic acyclic graph are applied to a dynamic multilayer perceptron network graph that was generated based on the subject data resulting in the output.

### BACKGROUND

Deep learning is a type of machine learning that attempts to model high-level abstractions in data by using multiple processing layers or multiple non-linear transformations. Deep learning uses representations of data, typically in vector format, where each datum corresponds to an observation with a known outcome. By processing over many observations with known outcomes, deep learning allows for a model to be developed that can be applied to a new observation for which the outcome is not known.

Some deep learning techniques are based on interpretations of information processing and communication patterns within nervous systems. One example is an artificial neural network. Artificial neural networks are a family of deep learning models based on biological neural networks. They are used to estimate functions that depend on a large number of inputs where the inputs are unknown. In a classic presentation, artificial neural networks are a system of interconnected nodes, called “neurons,” that exchange messages via connections, called “synapses” between the neurons.

An example, classic artificial neural network system can be represented in at least three layers: the input layer, the hidden layer, and the output layer. Each layer contains a set of neurons. Each neuron of the input layer is connected via numerically weighted synapses to nodes of the hidden layer, and each neuron of the hidden layer is connected to the neurons of the output layer by weighted synapses. Each neuron has an associated activation function that specifies whether the neuron is activated based on the stimulation it receives from its inputs synapses. Some artificial neural network systems include multiple hidden layers between the input layer and the output layer.

An artificial neural network is trained using examples. During training, a data set of known inputs with known outputs is collected. The inputs are applied to the input layer of the network. Based on some combination of the value of the activation function for each input neuron, the sum of the weights of synapses connecting input neurons to neurons in the hidden layer, and the activation function of the neurons in the hidden layer, some neurons in the hidden layer will activate. This, in turn, will activate some of the neurons in the output layer based on the weight of synapses connecting the hidden layer neurons to the output neurons and the activation functions of the output neurons. The activation of the output neurons is the output of the network, and this output is typically represented as a vector. Learning occurs by comparing the output generated by the network for a given input to that input's known output. Using the difference between the output produced by the network and the expected output, the weights of synapses are modified starting from the output side of the network and working toward the input side of the network, in a process is generally called backpropagation. Once the difference between the output produced by the network is sufficiently close to the expected output (defined by a cost function of the network), the network is said to be trained to solve a particular problem. While this example explains the concept of artificial neural networks using one hidden layer, many artificial neural networks include several hidden layers.

One type of artificial neural network model is a recurrent neural network. In a traditional artificial neural network, the inputs are independent of previous inputs, and each training cycle does not have memory of previous cycles. This approach removes the context of an input (e.g., the inputs before it) from training, which is not advantageous for inputs modeling sequences, such as sentences or statements. Recurrent neural networks, however, consider current input and the output from a previous input, resulting in the recurrent neural network having a “memory” which captures information regarding the previous inputs in a sequence. Recurrent neural networks are frequently used in text translation applications, for example, because text is inherently sequential and highly contextual.

One application of recurrent neural networks is described in applicant's co-pending application “Deep Learning Source Code Analyzer and Repairer,” application Ser. No. 15/410,005, filed Jan. 26, 2017. In the '005 application, recurrent neural networks are trained to detect and repair defects in source code before the source code is compiled. While the described techniques provide accuracy advantages over traditional static code analysis techniques, significant pre-processing is required to prepare source code data sets, which are inherently non-sequential, for application to a recurrent neural network, which is typically used in applications involving sequences.

### BRIEF DESCRIPTION OF THE DRAWINGS

FIG. 1 illustrates a recurrent neural network architecture consistent with disclosed embodiments.

FIG. 2 illustrates another representation of the recurrent neural network architecture consistent with disclosed embodiments.

FIG. 3 illustrates one example of a dynamic multilayer perceptron network architecture consistent with disclosed embodiments.

FIG. 4 illustrates one example of an abstract syntax tree and dynamic multilayer perceptron network architecture for a source code sample consistent with disclosed embodiments.

FIG. 5 illustrates, in block form, a network architecture system for analyzing source code consistent with disclosed embodiments.

FIG. 6 illustrates, in block form, a data and process flow for training a machine learning system using dynamic multilayer perceptrons to detect defects in source code consistent with disclosed embodiments.

FIG. 7 is a flowchart representation of a training process consistent with disclosed embodiments.

FIG. 8 illustrates, in block form, a data and process flow for detecting defects in source code using a machine learning system using dynamic multilayer perceptrons consistent with disclosed embodiments.

FIG. 9 is a flowchart representation of a utilization process consistent with disclosed embodiments.

FIG. 10 is a computer architecture diagram showing one illustrative computer hardware architecture for implementing aspects of disclosed embodiments.

### DETAILED DESCRIPTION

The present disclosure describes embodiments of machine learning techniques for training and using neural networks having a tree structure that models inherently non-sequential data. The present embodiments describe neural networks employing a dynamic multilayer perceptron (DMLP)—a multilayer perceptron that is dynamically generated based on the structure of the data being applied to the neural network. Unlike a traditional multilayer perceptron network or traditional recurrent neural network where training data or subject data is configured to fit the architecture of the network, DMLPs are dynamically created to fit the structure of the training data or the subject data.

DMLPs provide advantages over traditional multilayer perceptron networks or traditional recurrent neural networks in applications where training data or subject data is inherently non-sequential or conditional. Traditionally in such applications, non-sequential data must be pre-processed and configured into a sequence before being applied to the neural network for training or application purposes. Pre-processing adds additional computation steps requiring computing resources that can lead to inefficiencies when training or using traditional multilayer perceptron networks or traditional recurrent neural networks.

As DMLPs provide a more natural fit between non-sequential data and machine learning model, DMLPs also provide the advantages of reducing the amount of training data needed to train a neural network that will be applied to non-sequential data. By reducing the amount of training data needed, DMLPs can be trained faster than traditional multilayer perceptron networks or traditional recurrent neural networks for applications involving non-sequential data, providing additional efficiency advantages over these traditional techniques. And, DMLPs can be more effective than traditional machine learning techniques in applications where training data is scarce and non-sequential. Moreover, because DMLPs provide a more natural fit between non-sequential data and machine learning model, the accuracy of the neural network to perform the task for which it is trained improves.

DMLPs differ from traditional neural network models in that they are able to accept a graph (or data that is conceptually a graph) as input and provide either a single output or a graph as output, depending on application. In some implementations, the input graph is typically a directed acyclic graph, which can be a finite directed graph with many nodes and edges where each edge is directed away from one node to another so that no transversal of the graph loops back to the node at the start of the transversal. A tree is one type of directed acyclic graph, for example. The input graph has the same topology as the DMLP graph and the input value at each node in the directed acyclic graph can be applied to the DMLP graph simultaneously during training or processing.

In a machine learning system using DMLPs, input can be transformed into a dynamic acyclic graph, and a corresponding DMLP network graph can be generated based on the topology of the input dynamic acyclic graph. Once the dynamic multilayer perceptron network has been generated, each node of the dynamic acyclic graph can be encoded and provided as input to the DMLP network graph. In this way, the DMLP network graphs receives a graphical representation of data as input.

As mentioned above, the concept of weights is common to most neural networks and are used to specify the amount of influence a neuron has on neurons dependent upon, or connected to, it. For a machine learning system using DMLPs, the goal during training is to find a weight set that can be applied to multiple DMLPs, regardless of the topology of those DMLPs to arrive at a consistent result for the task the machine learning system performs. In some respects, this is similar to the goal of training a classic artificial neural network—backpropagation techniques are typically used to tune the weights of a network with a fixed topology to determine a weight set for that network. The weight set is then used in an artificial neural network with the same fixed topology. Machine learning systems using DMLP differ, however, because the topology of the network is not fixed and varies depending on the input to the network. Thus, the goal of training a machine learning system using DMLPs is to find a consistent weight set that may be applied to every synapse or edge in a DMLP network graph regardless of network topology. Techniques for accomplishing this goal are described in more detail below.

An example application where a machine learning system using DMLPs can be useful is in source code analysis. Source code is inherently conditional and non-sequential—as source code is compiled or interpreted, conditions may arise in the code which may redirect processing or the flow of information. For example, source code often contains conditional statements (e.g., “if” or “switch” statements), loop statements (e.g., “for,” “while” or “do while”), and function calls that may branch execution of away from the current processing or interpreting sequence. Partially for this reason, source code is often represented as a graph or tree, such as an abstract syntax tree, as opposed to a sequence. While source code can be applied as input to a traditional recurrent neural network, for example as described in applicant's co-pending application “Deep Learning Source Code Analyzer and Repairer,” application Ser. No. 15/410,005, filed Jan. 26, 2017, the source code must be adapted to fit the expected input sequence length. And, the conditional context of the source code is reduced or eliminated entirely because traditional recurrent neural networks rely on the sequential nature of data sets for context. But, DMLPs can allow a machine learning system to incorporate the non-sequential nature of source code while learning and performing its source code analysis tasks.

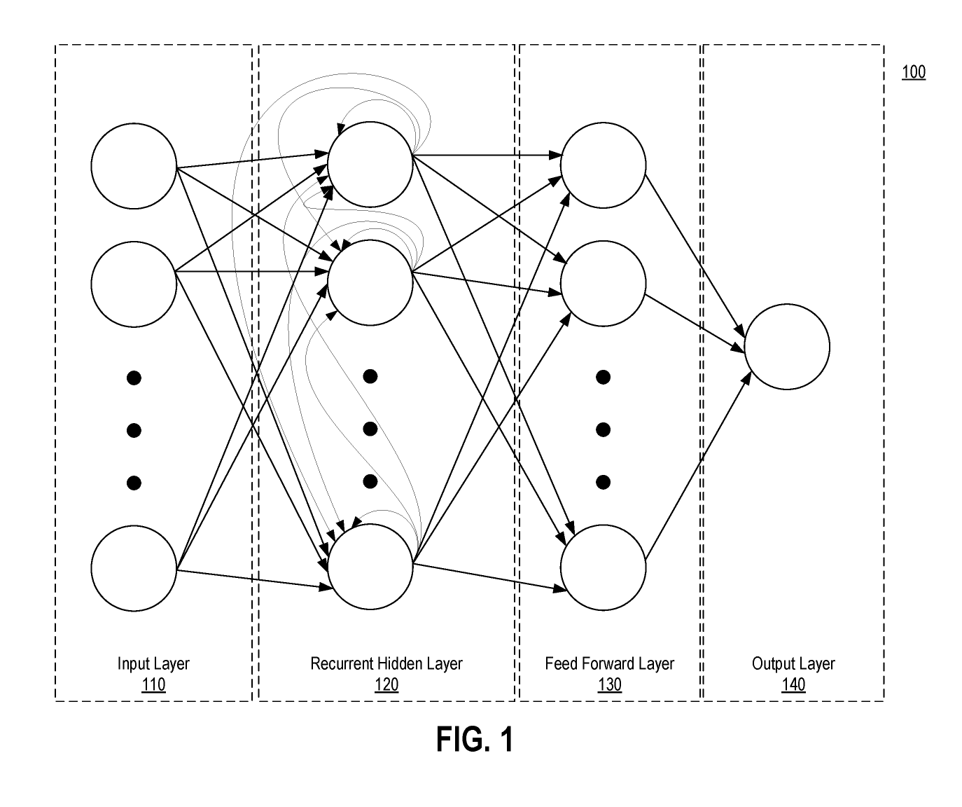

To further explain DMLPs and provide background as to their structure, FIG. 1 shows generic recurrent neural network architecture 100. Recurrent neural network architecture 100 includes four layers, input layer 110, recurrent hidden layer 120, feed forward layer 130, and output layer 140. Recurrent neural network architecture 100 can be fully connected for input layer 110, recurrent hidden layer 120, and feed forward layer 130. Recurrent hidden layer 120 is also fully connected with itself. In this manner, a classifier employing recurrent neural network architecture 100 can be trained over a series of time steps so that the output of recurrent hidden layer 120 for time step t is applied to the neurons of recurrent hidden layer 120 for time step t+1.

While FIG. 1 illustrates input layer 110 including three neurons, the number of neurons is variable, as indicated by the “ . . . ” between the second and third neurons of input layer 110 shown in FIG. 1. According to some embodiments, the number of neurons in input layer 110 corresponds to the dimensionality of vectors that represent encoding of input data. For example, a classifier employing recurrent neural network architecture 100 may classify natural language text. Before application to recurrent neural network architecture 100, words may be encoded as vectors using an encoding dictionary. The dimensionality of the vectors, and accordingly the number of neurons in input layer 110, may corresponds to the number of words in the encoding dictionary (which may also include an unknown statement vector). For example, for an encoding dictionary including encoding for 1,024 statements, each vector has 1,024 elements (using a one-of-k encoding scheme) and input layer 110 has 1,024 neurons. Also, recurrent hidden layer 120 and feed forward layer 130 include the same number of neurons as input layer 110. Output layer 140 includes one neuron, in some embodiments.

In some embodiments, input layer 110 can include an embedding layer, similar to the one described in T. Mikolov et al., “Distributed Representations of Words and Phrases and their Compositionality,” Proceedings of NIPS (2013), which is incorporated by reference in its entirety (available at http://papers.nips.cc/paper/5021-distributed-representations-of-words-and-phrases-and-their-compositionality.pdf). In such embodiments, input layer 110 assigns a vector of floating point values for an index corresponding with a statement or word. At initialization, the floating point values in the vectors are randomly assigned. During training, the values of the vectors can be adjusted. By using an embedding layer, significantly more statements can be encoded for a given vector dimensionality than in a one-of-k encoding scheme. For example, for a 256-dimension vector, 256 statements (including the unknown statement vector) can be represented using one-k-encoding, but using an embedding layer can result in tens of thousands of statement representations. Also, recurrent hidden layer 120 and feed forward layer 130 include the same number of neurons as input layer 110. Output layer 140 includes one neuron, in some embodiments. In embodiments employing an embedding layer, the number or neurons in recurrent hidden layer 120 and feed forward layer 130 can be equal to the number of neurons in input layer 110.

According to some embodiments, the activation function for the neurons of recurrent neural network architecture 100 can be Tan H or Sigmoid. Recurrent neural network architecture 100 can also include a cost function, which in some embodiments, is a binary cross entropy function. Recurrent neural network architecture 100 can also use an optimizer, which can include, but is not limited to, an Adam optimizer in some embodiments (see, e.g., D. Kingma and J. Ba, “Adam: A Method for Stochastic Optimization,” 3rd International Conference for Learning Representations, San Diego, 2015, incorporated by reference herein in its entirety).

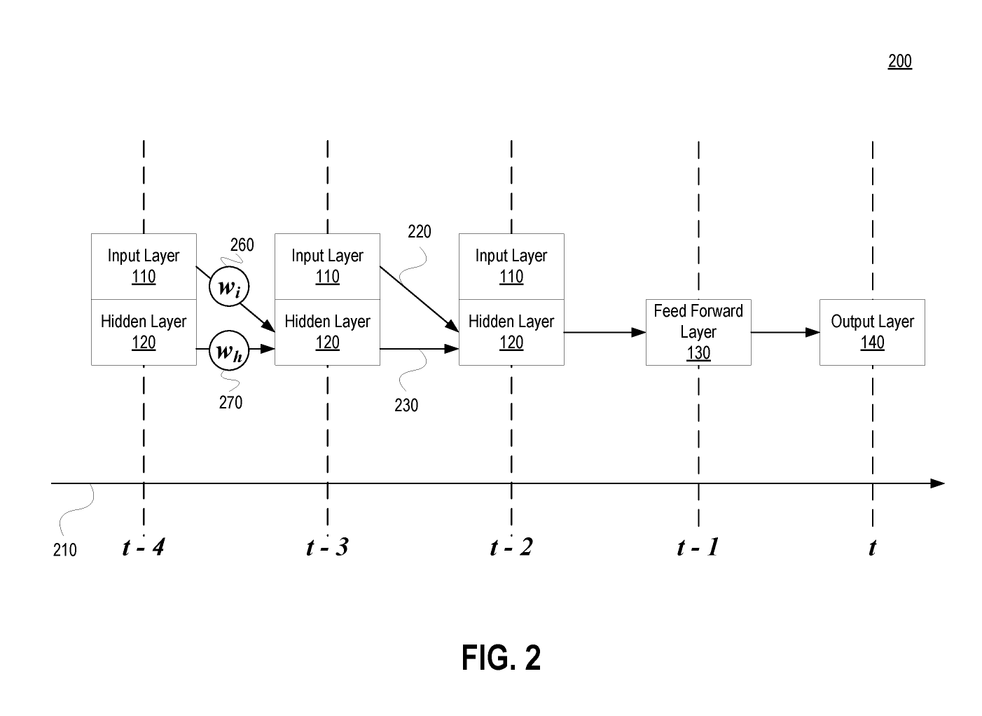

FIG. 2 illustrates representation 200 of recurrent neural network architecture 100. Representation 200 shows the layers of recurrent neural network architecture along timeline 210. The value represented at output layer 140 of recurrent neural network architecture 200 at time t is dependent on the values of vectors applied to input layer 110 at several previous time steps, the value of vectors of hidden layer 120 at several previous time steps, and the value of the vectors of the feed forward layer at the previous time step, t−1. Representation 200 includes four previous time steps t−4, t−3, t−2, and t−1, but the number of previous time steps affecting the value represented at the output layer 140 can vary depending on the number of hidden layers in recurrent neural network architecture 100.

As shown in FIG. 2, the value of hidden layer 120 is dependent on the value of input layer 110 and hidden layer 120 of the previous time step, as well as weights and the activation function of each neuron in hidden layer 120. For example, the value of hidden layer 120 at time step t−2 is dependent upon the value of input layer 110 and the value of hidden layer 120 at time step t−3, while the value of hidden layer 120 at time step t−3 is dependent upon the value of input layer 110 and the value of hidden layer 120 at time step t−4. The dependence of hidden layer 120 at a particular time step on values of input layer 110 and hidden layer 120 allows recurrent neural network architecture 100 to maintain an internal state or memory to provide context for a sequence of inputs applied to input layer 110. In this way, the value of output layer 140 depends not only on the current input applied to input layer 110 but also one or more previous inputs, providing sequential context to the output of the recurrent neural network architecture 100.

In FIG. 2, each of input layer 110, hidden layer 120, feed forward layer 130, and output layer 140 are represented as blocks, but each block represents a collection of nodes or neurons, as described with respect to FIG. 1. For example, each of input layer 110, hidden layer 120, feed forward layer 130, and output layer 140 may contain 1024 individual neurons and input to recurrent neural network architecture 100 may be a vector of 1024 elements. The number of individual neurons per layer may vary from embodiment to embodiment depending on application. Each neuron in the layers of representation 200 may have an associated activation function.

As mentioned above with respect to FIG. 1, each edge 220 of recurrent neural network architecture 100 may be associated with a weight that affects the influence a value of neuron in one layer has on the neurons to which it is connected in its dependent layers. In some embodiments, edge 220 connecting input layer 110 to hidden layer 120 has an associated weight matrix 260 that is a collection of the weights for the individual synapses connecting neurons of input layer 110 to hidden layer 120. Similarly, edge 230 connecting hidden layer 120 of a previous time step to hidden layer 120 has an associated weight matrix 260 that is a collection of the weights for the individual synapses connecting neurons of input layer 110 to hidden layer 120.

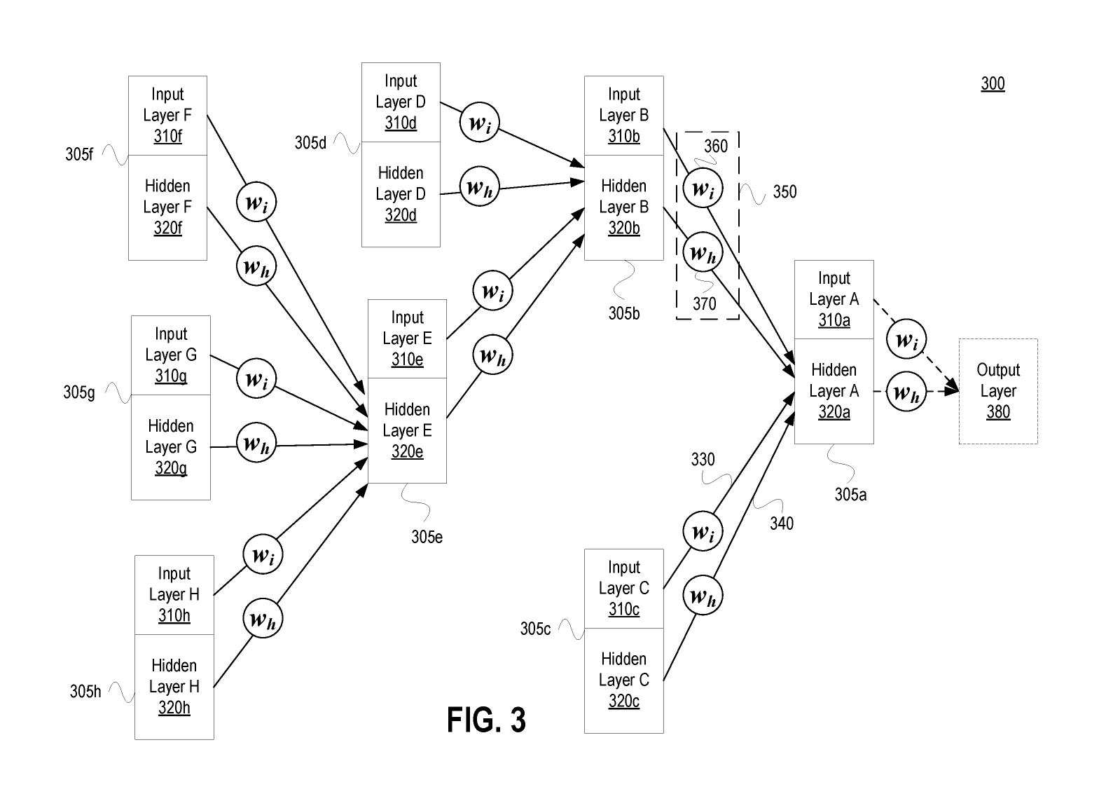

With that background in mind, FIG. 3 illustrates one embodiment of a dynamic multilayer perceptron network graph 300 consistent with disclosed embodiments. The embodiment of dynamic multilayer perceptron network graph 300 shown in FIG. 3 includes eight nodes 305 (sub-labeled a-h in FIG. 3). Dynamic multilayer perceptron network graph 300 includes node 305a, which may serve as the root. Dynamic multilayer perceptron network graph 300 includes three levels. Node 305b and node 305c are arranged in one level that is below and feeds into root node 305a. Node 305d and node 305e are arranged in a second-level that feeds into node 305b. Node 305f, node 305g, and node 305h are arranged in a third level that feeds into node 305e. Dynamic multilayer perceptron network graph 300 also includes an optional output layer 380.

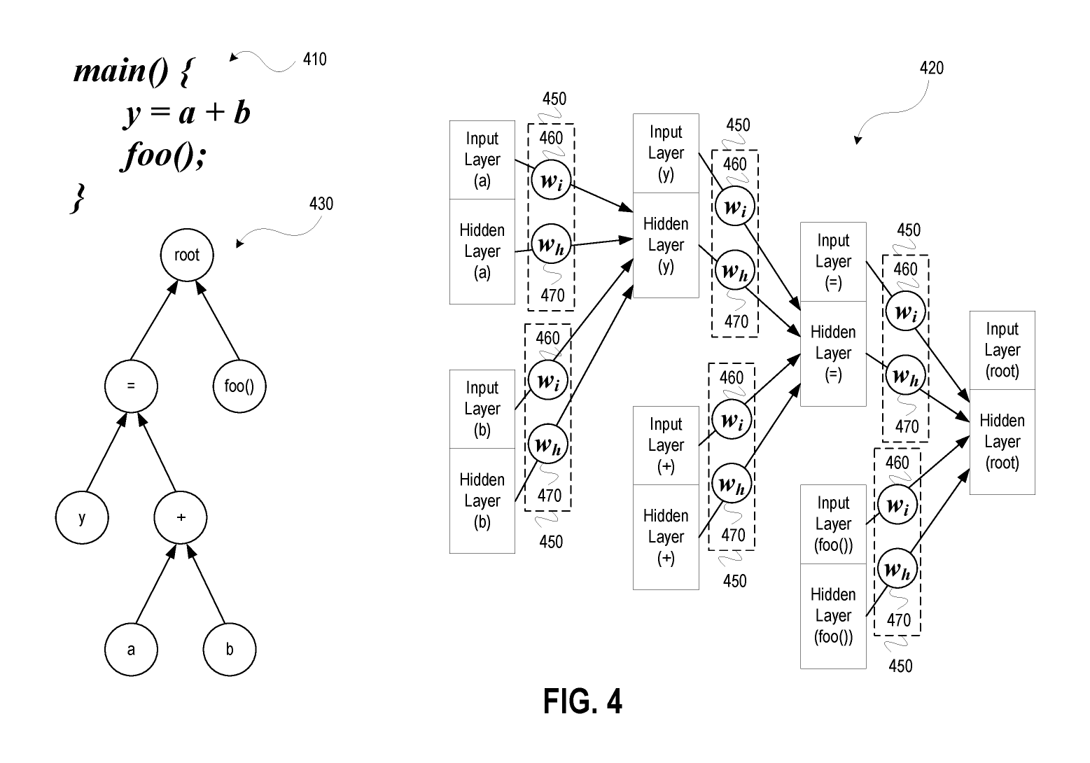

The structure of dynamic multilayer perceptron network graph 300 may depend on the structure of the data for which dynamic multilayer perceptron network graph 300 is modeling. Consistent with disclosed embodiments, the topology of dynamic multilayer perceptron network graph 300 is the same as a directed acyclic graphical representation of the data that will be applied as input to the network. An example of this is shown in FIG. 4 and explained in more detail below.

Each node 305 of dynamic multilayer perceptron network graph 300 includes input layer 310 and hidden layer 320. Input layer 310 represents a collection of neurons or sub-nodes that accept vectorized input. For example input layer 310 may include several hundred or several thousand individual inputs that can accept floating-point values for integer values corresponding to a vectorized representation of data, similar to input layer 110 described above with respect to FIG. 1 and FIG. 2. Likewise hidden layer 320 may also represent a collection of neurons or sub-nodes that accept vectorized input, and the dimensionality of hidden layer 320 can be the same as the dimensionality of input layer 310. For example if input layer 310 corresponds to 1,024 values, both input layer 310 and hidden layer 320 would include 1,024 neurons or sub-nodes.

The neurons of input layer 310 and hidden layer 320 have an associated activation function that specifies whether the neuron is activated based on the stimulation it receives from its inputs. For neurons in the input layer 310, the stimulation each receives is based upon the input values applied to it and their activation functions are triggered based on this stimulation. For neurons in the hidden layer 320, the stimulation it receives is based on the activation of neurons in the input layers and hidden layers upon which the neurons in the hidden layer depend. Consistent with disclosed embodiments, weights may be applied to strengthen or diminish the input to a neuron, which can affect whether a neuron's activation function activates.

In a dynamic multilayer perceptron network, hidden layer 320 of node 305 at one level may be dependent upon input layer 310 and hidden layer 320 of another node 305 at a lower level within the network. For example, as shown in dynamic multilayer perceptron network graph 300, hidden layer A 320a is dependent, in part, on input layer C 310c via input-to-hidden edge 330 and hidden layer C 320c via hidden-to-hidden edge 340. For simplicity, edges 330 and 340 are the only edges labeled in FIG. 3, but as shown in FIG. 3, each hidden layer 320 in dynamic multilayer perceptron network graph 300 is dependent upon some combination of input layers 310 and hidden layers 320 of nodes in lower levels of the dynamic multilayer perceptron network graph 300, and are likewise connected via input-to-hidden edges 330 or hidden-to-hidden edges 340.

In a dynamic multilayer perceptron network, any node 305 may be a parent or child to one or more nodes, and the topology of a dynamic multilayer perceptron network is not strictly binary. For example, node 305e has three child nodes 305f-305h. While not shown in FIG. 3, some dynamic multilayer perceptron network may have nodes 305 with only one child.

According to some embodiments, input-to-hidden weight matrix 360 can be applied to input-to-hidden edge 330 to modify the influence the values applied to input layer 310 have on dependent hidden layers 320. Likewise, hidden-to-hidden weight matrix 370 can be applied to hidden-to-hidden edge 340 to modify the influence the values of hidden layer 320 have on dependent hidden layers 320. As an example, input-to-hidden weight matrix 360 may be applied to the values of input layer B 310b and hidden-to-hidden weight matrix 370 may be applied to the values of hidden layer B 320b to influence the values of hidden layer A 320a. As shown in dynamic multilayer perceptron network graph 300, hidden layer A 320a is also dependent upon input layer C 310c and hidden layer C 320c. Accordingly input-to-hidden weight matrix 360 can be applied to the values of input layer C 310c and hidden-to-hidden weight matrix 370 can be applied values of hidden layer C 320c to influence the values of hidden layer A 320a.

In a trained dynamic multilayer perceptron network, input-to-hidden weight matrix 360 is constant across input-to-hidden edges 330, and hidden-to-hidden weight matrix 370 is constant across hidden-to-hidden edges 340, and constitute the weight set 350 of the dynamic multilayer perceptron network. While in some instances, input-to-hidden weight matrix 360 and hidden-to-hidden weight matrix 370 may have the same values, in most cases the values of input-to-hidden weight matrix 360 and hidden-to-hidden weight matrix 370 will be different.

In some embodiments, dynamic multilayer perceptron network graph 300 has output layer 380. Output layer 380 may include one or more neurons which can be dependent upon input layer 310 and hidden layer 320 of the root node of dynamic multilayer perceptron network graph 300. Output layer 380 may also depend on input-to-hidden weight matrix 360 (which may be applied to the edge connecting input layer 310 of the root node to output layer 380) and/or hidden-to-hidden weight matrix 370 (which may be applied to the edge connecting hidden layer 320 of the root node to output layer 380). In some embodiments, dynamic multilayer perceptron network graph 300 does not include output layer 380 and the output of dynamic multilayer perceptron network graph 300 may be the value of hidden layer 320 of the root.

As training data and subject data can result in dynamic multilayer perceptron network graphs of different topologies, the training goal for a training dynamic multilayer perceptron network is to find a consistent weight set 350 that can apply to dynamic multilayer perceptron network graphs of different topologies. This goal can be further demonstrated with discussion of an example application for developing dynamic multilayer perceptron networks to analyze computer source code.

FIG. 4 illustrates a simplified example of source code 410 transformed into a dynamic multilayer perceptron network 420 for discussion purposes. As mentioned above, source code is typically non-sequential in nature—source code may branch in logical flow based on the presence of conditions. When analyzing source code in a machine learning system using dynamic multi-perceptrons, source code may first be converted to a directed acyclic graph representing the logical flow of the source code. Some examples of directed acyclic graph representing source code include abstract syntax trees and control flow graphs. As shown in FIG. 4, source code 410 can be transformed into abstract syntax tree 430. The structure of abstract syntax tree 430 can be used to generate dynamic multilayer perceptron network 420, which has the same topology as abstract syntax tree 430. For example, abstract syntax tree 420 has a root (corresponding to the “main( )” function) with two children, one representing the assignment operator and another representing the call to the method “foo( )”. Likewise, dynamic multilayer perceptron network 420 has a root node with two children, one representing the assignment operator another representing the call to the method “foo( ).”

As shown in FIG. 4, each node of dynamic multilayer perceptron network 420 includes an input layer and hidden layer as discussed above with respect to FIG. 3. In addition, each hidden layer of each node and dynamic multilayer perceptron network 420 is dependent upon the input layers and hidden layers of its child nodes. For example, the hidden layer of the assignment node in dynamic multilayer perceptron network 420 has edges feeding into it from the input layer and hidden layer of the y node and the input layer and hidden layer of the addition node.

Also, as shown in FIG. 4, the input-to-hidden edges of dynamic multilayer perceptron network 420 have an applied input-to-hidden weight matrix 460 and the hidden edges of dynamic multilayer perceptron network 420 have an applied hidden-to-hidden weight matrix 470. Input-to-hidden weight matrix 460 and hidden-to-hidden weight matrix 470 make up weight set 450 for dynamic multilayer perceptron network 420. As shown in FIG. 4, weight set 450 is applied to each input-to-hidden and hidden-to-hidden edge pair, and as mentioned above, the values of weight set 450 are consistent across dynamic multilayer perceptron network 420.

In a machine learning system using dynamic multilayer perceptrons, data can be transformed into a dynamic acyclic graph, and a dynamic multilayer perceptron network can be generated based on the topology of the dynamic acyclic graph. Once the dynamic multilayer perceptron network has been generated, each node of the dynamic acyclic graph can be encoded and provided as input to the dynamic multilayer perceptron network. Using the example of FIG. 4, a machine learning system may transform source code 410 into abstract syntax tree 430 (which is a type of dynamic acyclic graph) and generate dynamic multilayer perceptron network 420 from it. Once dynamic multilayer perceptron network 420 is created, the machine learning system may encode each node of abstract syntax tree 430 and apply it to the input layers of dynamic multilayer perceptron network 420. In this way, dynamic multilayer perceptron network 420 can receive a graphical representation (e.g., abstract syntax tree 430) of data (e.g., source code 410) for training purposes or for utilization purposes as described with respect to, and consistent with, disclosed embodiments. For a machine learning system that has completed training, the values of weight set 450 are dictated by the outcome of training. For a machine learning that is training, the values of the weight set 450 may be adjusted during the training process consistent with disclosed embodiments.

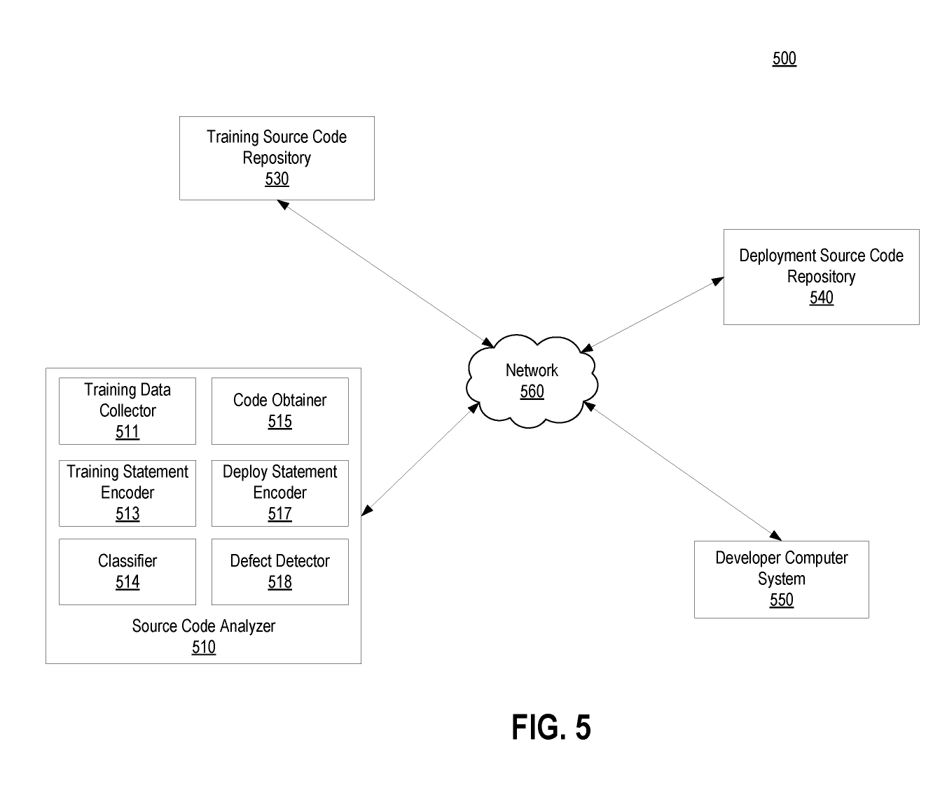

To further describe one application of a machine learning system utilizing DMLPs, FIG. 5 illustrates a source code analysis system 500, in block form, that uses source code training data to train a machine learning system using DMLPs to identify a classification of source code in a variety of ways. For example, system 500 can be used to analyze source code for defects. As another example, system 500 can be used to identify the task a source code is intended to perform.

In the embodiment illustrated in FIG. 5, the components of system 500, such as source code analyzer 510, training source code repository 530, deployment source code repository 540, and developer computer system 550, can communicate with each other across network 560. System 500 outlined in FIG. 5 can be computerized, wherein each of the illustrated components comprises a computing device that is configured to communicate with other computing devices via network 560. For example, developer computer system 550 can include one or more computing devices, such as a desktop, notebook, or handheld computing device that is configured to transmit and receive data to/from other computing devices via network 560. Similarly, source code analyzer 510, training source code repository 530, and deployment source code repository 540 can include one or more computing devices that are configured to communicate data via the network 560. In some embodiments, these computing systems would be implemented using one or more computing devices dedicated to performing the respective operations of the systems as described herein.

Depending on the embodiment, network 560 can include one or more of any type of network, such as one or more local area networks, wide area networks, personal area networks, telephone networks, and/or the Internet, which can be accessed via any available wired and/or wireless communication protocols. For example, network 560 can comprise an Internet connection through which source code analyzer 510 and training source code repository 530 communicate. Any other combination of networks, including secured and unsecured network communication links are contemplated for use in the systems described herein.

Training source code repository 530 can be one or more computing systems that store, maintain, and track modifications to one or more source code bases. Generally, training source code repository 530 can be one or more server computing systems configured to accept requests for versions of a source code project and accept changes as provided by external computing systems, such as developer computer system 550. For example, training source code repository 530 can include a web server and it can provide one or more web interfaces allowing external computing systems, such as source code analyzer 510, and developer computer system 550 to access and modify source code stored by training source code repository 530. Training source code repository 530 can also expose an API that can be used by external computing systems to access and modify the source code it stores. Further, while the embodiment illustrated in FIG. 5 shows training source code repository 530 in singular form, in some embodiments, more than one training source code repository having features similar to training source code repository 530 can be connected to network 560 and communicate with the computer systems described in FIG. 5, consistent with disclosed embodiments.

In addition to providing source code and managing modifications to it, training source code repository 530 can perform operations for tracking defects in source code and the changes made to address them. In general, when a developer finds a defect in source code, she can report the defect to training source code repository 530 using, for example, an API or user interface made available to developer computer system 550. The potential defect may be included in a list or database of defects associated with the source code project. When the defect is remedied through a source code modification, training source code repository 530 can accept the source code modification and store metadata related to the modification. The metadata can include, for example, the nature of the defect, the location of the defect, the version or branch of the source code containing the defect, the version or branch of the source code containing the fix for the defect, and the identity of the developer and/or developer computer system 550 submitting the modification. In some embodiments, training source code repository 530 makes the metadata available to external computing systems.

According to some embodiments, training source code repository 530 is a source code repository of open source projects, freely accessible to the public. Examples of such source code repositories include, but are not limited to, GitHub, SourceForge, JavaForge, GNU Savannah, Bitbucket, GitLab and Visual Studio Online.

Within the context of system 500, training source code repository 530 stores and maintains source code projects used by source code analyzer 510 to train a machine learning system using DMLPs to detect defects within source code, consistent with disclosed embodiments. This differs, in some aspects, with deployment source code repository 540. Deployment source code repository 540 performs similar operations and offers similar functions as training source code repository 530, but its role is different. Instead of storing source code for training purposes, deployment source code repository 540 can store source code for active software projects for which validation and verification processes occur before deployment and release of the software project. In some aspects, deployment source code repository 540 can be operated and controlled by an entirely different entity than training source code repository 530. As just one example, training source code repository 530 could be GitHub, an open source code repository owned and operated by GitHub, Inc., while deployment source code repository 540 could be an independently owned and operated source code repository storing proprietary source code. However, neither training source code repository 530 nor deployment source code repository 540 need be open source or proprietary. Also, while the embodiment illustrated in FIG. 5 shows deployment source code repository 540 in singular form, in some embodiments, more than one deployment source code repository having features similar to deployment source code repository 540 can be connected to network 560 and communicate with the computer systems described in FIG. 5, consistent with disclosed embodiments.

System 500 can also include developer computer system 150. According to some embodiments, developer computer system 550 can be a computer system used by a software developer for writing, reading, modifying, or otherwise accessing source code stored in training source code repository 530 or deployment source code repository 540. While developer computer system 550 is typically a personal computer, such as one operating a UNIX, Windows, or Mac OS based operating system, developer computer system 550 can be any computing system configured to write or modify source code. Generally, developer computer system 550 includes one or more developer tools and applications for software development. These tools can include, for example, an integrated developer environment or “IDE.” An IDE is typically a software application providing comprehensive facilities to software developers for developing software and normally consists of a source code editor, build automation tools, and a debugger. Some IDEs allow for customization by third parties, which can include add-on or plug-in tools that provide additional functionality to developers. In some embodiments of the present disclosure, IDEs executing on developer computer system 550 can include plug-ins for communicating with source code analyzer 510, training source code repository 530, and deployment source code repository 540. According to some embodiments, developer computer system 550 can store and execute instructions that perform one or more operations of source code analyzer 510.

Although FIG. 5 depicts source code analyzer 510, training source code repository 530, deployment source code repository 540, and developer computer system 550 as separate computing systems located at different nodes on network 560, the operations of one of these computing systems can be performed by another without departing from the spirit and scope of the disclosed embodiments. For example, in some embodiments, the operations of source code analyzer 510 may be performed by one physical or logical computing system. As another example, training source code repository 530 and deployment source code repository 540 can be the same physical or logical computing system in some embodiments. Also, the operations performed by source code analyzer 510 can be performed by developer computer system 550 in some embodiments. Thus, the logical and physical separation of operations among the computing systems depicted in FIG. 1 is for the purpose of simplifying the present disclosure and is not intended to limit the scope of any claims arising from it.

According to some embodiments, system 500 includes source code analyzer 510. Source code analyzer 510 can be a computing system that analyzes training source code to train a machine learning system using DMLPs for detecting defects in a software project's source code. As shown in FIG. 5, source code analyzer 510 can contain multiple modules and/or components for performing its operations, and these modules and/or components can fall into two categories—those used for training the machine learning system and those used for applying the trained machine learning system to source code from a development project.

According to some embodiments, source code analyzer 510 may train the machine learning system using first source code that is within a context to detect defects in second source code that is within that same context. A context can include, but is not limited to, a programming language, a programming environment, an organization, an end use application, or a combination of these. For example, the first source code (used for training the model) may be written in C++ and for a missile defense system. Using the first source code, source code analyzer 510 may train a machine learning system using DMLPs to detect defects within second source code that is written in C++ and is for a satellite system. As another non-limiting example, an organization may use first source code written in Java to train a machine learning system using DMLPs to detect defects within second source code written in Java for the user application.

In some embodiments, source code analyzer 510 includes training data collector 511, training control flow extractor 512, training statement encoder 513, and classifier 514 for training the machine learning system using DMLPs. These modules of source code analyzer 510 can communicate data between each other according to known data communication techniques and, in some embodiments, can communicate with external computing systems such as training source code repository 530 and deployment source code repository 540.

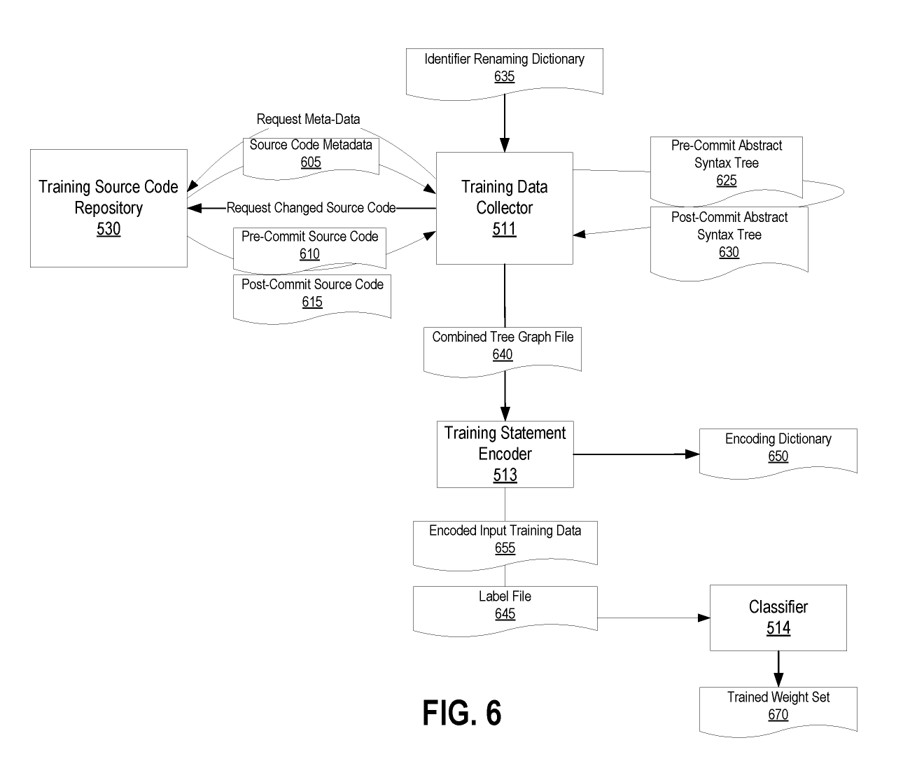

FIG. 6 shows a data and process flow diagram depicting the data transferred to and from training data collector 511, training statement encoder 513, and classifier 514 according to some embodiments.

In some embodiments, training data collector 511 can perform operations for obtaining source code used by source code analyzer 510 to train a machine learning system using DMLPs for detecting defects in source code. As shown in FIG. 6, training data collector 511 interfaces with training source code repository 530 to obtain source code metadata 605 describing source code stored in training source code repository 530. Training data collector 511 can, for example, access an API exposed by training source code repository 530 to request source code metadata 605. Source code metadata 605 can describe, for a given source code project, repaired defects to the source code and the nature of those defects. For example, a source code project written in the C programming language typically has one or more defects related to resource leaks. Source code metadata 605 can include information identifying those defects related to resource leaks and the locations (e.g., file and line number) of the repairs made to the source code by developers to address the resource leaks. Once the training data collector 511 obtains source code metadata 605, it can store it in a database for later access, periodic downloading of source code, reporting, or data analysis purposes. Training data collector 511 can access source code metadata 605 on a periodic basis or on demand.

Using source code metadata 605, training data collector 511 can prepare requests to obtain source code files containing fixed defects. According to some embodiments, the training data collector 511 can request the source code file containing the defect—pre-commit source code 610—and the same source code file after the commit that fixed the defect—post-commit source code 615. By obtaining source code metadata 605 first and then obtaining pre-commit source code 610 and post-commit source code 615 based on the content of source code metadata 605, training data collector 511 can minimize the volume of source code it analyzes to improve its operational efficiency and decrease load on the network from multiple, unneeded requests (e.g., for source code that has not changed). But, in some embodiments, training data collector 511 can obtain the entire source code base for a given project, without selecting individual source code files based on source code metadata 605, or obtain source code without obtaining source code metadata 605 at all.

According to some embodiments, training data collector 511 can also prepare source code for analysis by the other modules and/or components of source code analyzer 510. For example, training data collector 511 can perform operations for transforming pre-commit source code 610 and post-commit source code 615 from its normal storage format, which is likely text, to a directed acyclic graph representation. In some embodiments, training data collector 511 transforms pre-commit source code 610 and post-commit source code 615 into pre-commit abstract syntax tree 625 and post-commit abstract syntax tree 630, respectively. Training data collector 511 creates these abstract syntax trees (“ASTs”) for later generation of DMLP networks corresponding to the ASTs that are used for training the machine learning system. Pre-commit abstract syntax tree 625 and post-commit abstract syntax tree 630 can be stored in a data structure, object, or file, depending on the embodiment.

Although not shown in FIG. 6, training data collector 511 may transform pre-commit source code 610 and post-commit source code 615 into other directed cyclic graphical representations instead of, or in addition to, ASTs. For example, in some embodiments, training data collector 511 may transform pre-commit source code 610 and post-commit source code 215 into control flow graphs, and DMLP network graphs may be created based on the topology of these control flow graphs. In some embodiments, training data collector 511 may transform pre-commit source code 610 and post-commit source code 615 into ASTs and transform the ASTs into control flow graphs.

In some embodiments, when training data collector 511 may refactor and rename variables in pre-commit abstract syntax tree 625 and post-commit abstract syntax tree 630 to normalize them. Normalizing allows training statement encoder 613 to recognize similar code that primarily differs only with respect to the arbitrary variable names given to it by developers. In some embodiments, training data collector 511 uses shared identifier renaming dictionary 635 for refactoring the code. Identifier renaming dictionary 635 can be a data structure mapping variables in pre-commit abstract syntax tree 625 and post-commit abstract syntax tree 630 to normalized variable names used across source code data sets.

According to some embodiments, after refactoring and normalizing pre-commit abstract syntax tree 625 and post-commit abstract syntax tree 630, training data collector 511 can traverse pre-commit abstract syntax tree 625 and post-commit abstract syntax tree 630 using a depth-first search to compare their structure. When training control flow extractor 512 identifies differences between pre-commit abstract syntax tree 625 and post-commit abstract syntax tree 630, it can flag potentially defective trees and stores markers a data structure or test file representing “bad” trees or graphs. Similarly, training control flow extractor 512 identifies similarities between pre-commit abstract syntax tree 625 and post-commit abstract syntax tree 630, it can flag potentially defect-free trees and stores markers in a data structure or text file representing “good” trees or graphs. Training data collector 511 continues traversing both the pre-commit abstract syntax tree 625 and post-commit abstract syntax tree 630, while appending good and bad trees to the appropriate file or data structure, until it reaches the end of pre-commit abstract syntax tree 625 and post-commit abstract syntax tree 630.

According to some embodiments, after training control flow extractor 112 completes traversal of pre-commit abstract syntax tree 625 and post-commit abstract syntax tree 630, it will have created a list of bad trees and good trees, each of which are stored separately in a data structure or file. Then, as shown in FIG. 6, training data collector 511 creates combined tree graph file 640 that may later be used for training the machine learning system using DMLPs. To create combined tree graph file 640 training data collector 511 randomly selects bad trees and good tress from their corresponding file. In some embodiments, training data collector 511 selects an uneven ratio of bad trees and good trees. For example, training data collector 511 may select one bad tree for every nine good trees, to create a selection ratio of 10% bad trees for combined tree graph file 640. While the ratio of bad trees may vary across embodiments, one preferable ratio is 25% bad trees in combined tree graph file 640.

As also illustrated in FIG. 6, training data collector 511 creates label file 645. Label file 645 stores an indicator describing whether the flows in combined tree graph file 640 are defect-free (e.g., a good tree) or contain a potential defect (e.g., a bad tree). Label file 645 and combined tree graph file 640 may correspond on a line number basis. For example, the first line of label file 645 can include a good or bad indicator (e.g., a “0” for good, and a “1” for bad, or vice-versa) corresponding to the first line of combined tree graph file 640, the second line of label file 645 can include a good or bad indicator corresponding to the second line of combined tree graph file 640, and so on. In some embodiments, training data collector 511 may also include an indication of the type of defect based on an encoding scheme. For example, for a null pointer exception, label file may include a label indicating that the associated tree has a defect and the defect is a null pointer exception. Label file 645 may, in some implementations, store a vector representation for the good, bad, or bad-plus-type indicator. The values in label file 645 may represent expected output during training.

Returning to FIG. 5, source code analyzer 510 can also include training statement encoder 513. Training statement encoder 513 performs operations transforming the trees from combined tree graph file 640 into a format that can be used as inputs to train classifier 514. In some embodiments, a vector representation of the statements in the trees is used, while in other embodiments an index value (e.g., an integer value) that is converted by an embedding layer (discussed in more detail below) to a vector can be used. To limit the dimensionality of the vectors used by classifier 514 to train the machine learning system using DMLPs, training statement encoder 513 does not encode every unique statement within combined tree graph file 640; rather, it encodes the most common statements. To do so, training statement encoder 513 may create a histogram of the unique statements in combined tree graph file 640. Using the histogram, training statement encoder 513 identifies the most common unique statements and selects those for encoding. For example, training statement encoder 513 may use the top 1000 most common statements in combined tree graph file 640. The number of unique statements that training statement encoder 513 uses can vary from embodiment to embodiment, and can be altered to improve the efficiency and efficacy of defect detection depending on the domain of the source code undergoing analysis.

Once the most unique statements are identified, training statement encoder 513 creates encoding dictionary 650 as shown in FIG. 6. Training statement encoder 513 uses encoding dictionary 650 to encode the statements in combined tree graph file 640. According to one embodiment, training statement encoder creates encoding dictionary 650 using a “one-of-k” vector encoding scheme, which may also be referred to as a “one-hot” encoding scheme. In a one-of-k encoding scheme, each unique statement is represented with a vector including a total number of elements equaling the number of unique statements being encoded, wherein one of the elements is set to a one-value (or “hot”) and the remaining elements are set to zero-value. For example, when training statement encoder 513 vectorizes 1000 unique statements, each unique statement is represented by a vector of 1000 elements, one of the 1000 elements is set to 1, and the remainder are set to zero. The encoding dictionary maps the one-of-k encoded vector to the unique statement. While training statement encoder 513 uses one-of-k encoding according to one embodiment, training statement encoder 513 can use other vector encoding methods. In some embodiments, training statement encoder 513 encodes statements by mapping statements to an index value. The index value can later be assigned to a vector of floating point values that can be adjusted when classifier 514 trains classifier 514.

As shown in FIG. 6, once training statement encoder 513 creates encoding dictionary 650, it processes combined tree graph file 640 to encode it and create encoded input training data 655. For each statement in each tree in combined tree graph file 640, training statement encoder 513 replaces the statement with its encoded translation from encoding dictionary 650. For example, training statement encoder 513 can replace the statement with its vector representation for encoding dictionary 650, or index representation, as appropriate for the embodiment. For statements that are not included in encoding dictionary 650, training statement encoder 513 replaces the statement with a special value representing an unknown statement, which can be an all-one or all-zero vector, or an specific index value (e.g., 0), depending on the embodiment.

Returning to FIG. 5, source code analyzer also contains classifier 614. Classifier 614 uses disclosed embodiments to create a weight set that can be used by a machine learning system to detect defects in source code using DMLPs. As shown in FIG. 2, classifier 514 uses encoded input training 655 created by training statement encoder 513 and label file 645 to create trained neural network 270. For example, encoded input training data 655 (which includes encoded tree graphs) may represent input training data for classifier 514 and label file 645 may represent expected output for classifier 514. Consistent with disclosed embodiments, classifier 514 may employ DMLPs to generate weight set 670.

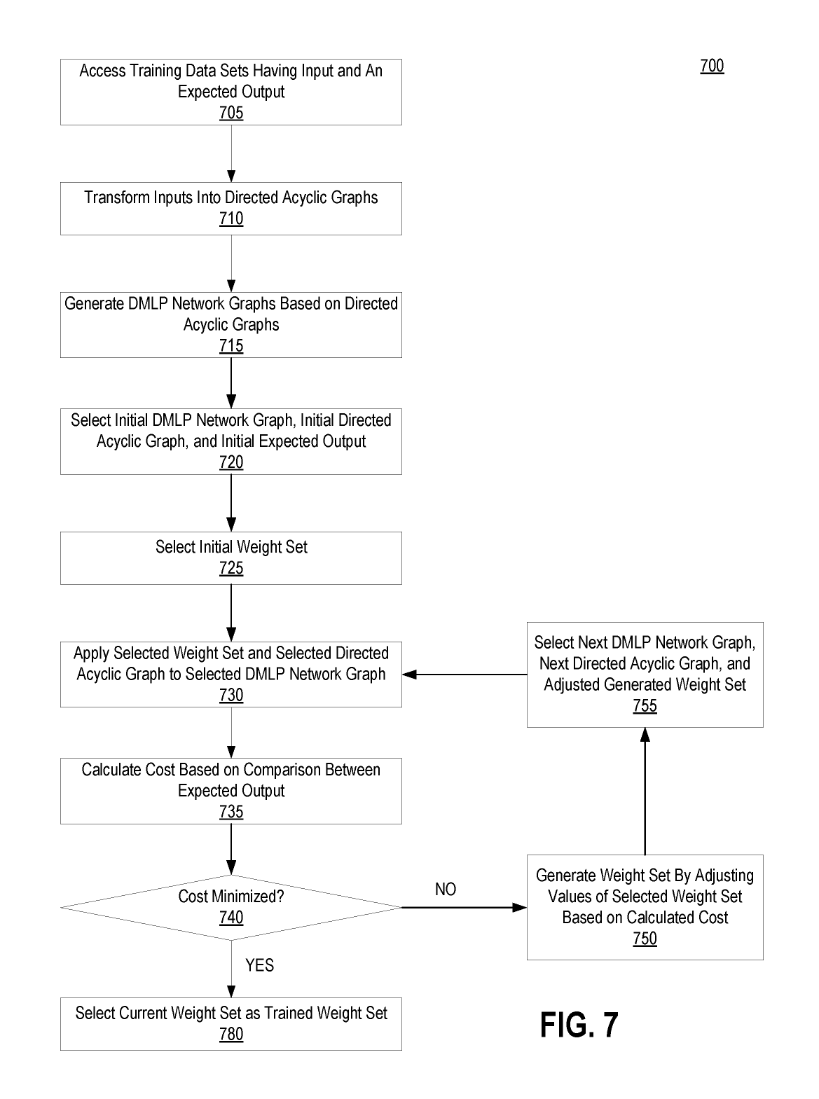

FIG. 7 shows a flowchart representing training process 700 for training a machine learning system using DMLPs. According to some embodiments, one or more steps of process 700 can be performed by one or more components of source code analyzer 510. For example, as described below, some steps of process 700 may be performed by training data collector while other steps may be performed by classifier 514. Moreover, the process below is described with respect to the components of source code analyzer 510 for ease of discussion. Process 700 may be implemented by other computer systems to train a machine learning system to use DMLPs to analyze inherently non-sequential data. That the description of FIG. 7 below refers to source code analyzer 510 or its components is not intended to limit the scope of the process to a particular application, machine, or apparatus.

In addition, while the steps of process 700 are explained in a particular order, the order of these steps may vary across embodiments. As just one example, steps 705, 710, and 715 may be performed prior to the process loop including steps 730 through 755 in some embodiments, while in other embodiments, steps 705, 710, and 715 may be performed as part of the process loop including steps 730 through 755 without limiting the scope of process 700.

At step 705, process 700 access training data sets having an input and an expected output. The input of the training data sets may be inherently non-sequential or conditional as opposed to sequential. As described herein, one example of inherently non-sequential data is source code. Other examples may include decision tree datasets for conducting troubleshooting, customer service, or performing some other task where performance of the task may rely on the presence or absence of conditions or categorization and analysis of collections of non-sequential documents such as websites.

Process 700 also accesses expected output for the training data. For training purposes, each input may have a corresponding expected output. For example, in source code training data, the expected output may be whether a code portion contains a defect and/or the type of defect within the code portion. As another example, for troubleshooting training data sets the expected output may be a resolution to a problem for which troubleshooting was occurring. The expected output may be binary representing the presence or absence of a condition (e.g., the corresponding source code input does or does not contain a defect) or the expected output may be non-binary (e.g., the corresponding source code input contains one of many classes of defect).

At step 710, process 700 transforms the input of the training data into a directed acyclic graph. Conversion of the training data may occur through analysis of it to determine appropriate nodes and connections between those nodes. In some implementations, known code libraries may be available to convert the input training data into directed acyclic graphs. For example, as converting source code to abstract syntax trees is part of a typical compilation process, may libraries exist for converting source code to abstract syntax trees. The directed acyclic graph may be represented as a data structure, text, image, or any other format. As a simple example, the directed acyclic graph may be represented in a data structure listing a set of nodes and an association table that lists parent/child pairs.

At step 715, process 700 can generate a DMLP network graphs based on the directed acyclic graphs generated in step 710. As discussed above with respect to FIG. 3, each DMLP network graph may have the same topology as the directed acyclic graph it is modeling. For example, the DMLP network graph and the directed acyclic graph may each have the same number of nodes and edges, and each node in both the DMLP network graph and the directed acyclic graphs may have the same parent-child relationships.

For sufficient training, the training data sets accessed in step 705 by process 700 may include hundreds, thousands, or even tens of thousands of inputs and associated expected outputs. The volume of training data may vary depending on the implementation and intended use of the machine learning system employing process 700. Process 700 iterates over these multiple training data sets, which is represented in FIG. 7 in step 720-step 755.

At step 720, process 700 selects the first training data set, which can include the DMLP network graph, directed acyclic graph, and expected output for that training data set. In some embodiments, the selection of the initial DM LP network graph, directed acyclic graph, and expected output is arbitrary. At step 725, process 700 also selects an initial weight set to apply the LP network graph. In some embodiments, the initial weight set includes an initial to hidden weight matrix of all zero elements and an initial hidden to hidden weight matrix of all zero elements. The initial weight set can also include an initial to hidden weight matrix of all one elements and initial hidden to hidden weight matrix of all one elements, or some other value. In some embodiments, trial and error may lead to optimized initial weight set values depending on implementation.

Once the initial DMLP network graph, initial directed acyclic graph, and initial expected output have been selected, and the initial weight the selected, process 700 applies the selected weight set (which for the first iteration is the initial weight set) to the selected DMLP network graph (which for the first iteration is the initial DMLP network graph selected in step 720). Process 700 also applies the selected directed acyclic graph (which for the first iteration is the initial directed acyclic graph selected in step 720) as input to the selected DMLP network graph.

Once the selected directed acyclic graph is applied to the selected DMLP network graph, process 700 determines the selected output of DMLP network graph by propagating the values applied as input to the DMLP network graph (the input directed acyclic graph) and compares it to the expected output associated with the selected directed acyclic graph provided his input to the DMLP network graph, at step 735. As part of that comparison, in some embodiments, process 700 may calculate a cost value from a cost function. For simplicity, a cost function can be a measure of how good the DMLP network graph performed with respect to the input applied to it—the larger the cost value determined by the cost function, the larger the difference between the expected output and the calculated output of the DMLP network graph. In some embodiments, classic backpropagation techniques that are applied to traditional artificial neural networks are applied to the DMLP network graph. Accordingly, the cost function used by process 700 is can be a cost function that satisfies assumptions for cost functions to be effective for backpropagation—(1) the cost function can be written as an average over error functions for individual training examples and (2) the cost function can be written as a function of the output of the DMLP network and not dependent upon the activation values individual nodes. Cost functions satisfying these conditions may be used by process 700. In some embodiments, the cost function is a binary cross entropy function.

At step 740, if the cost function is not sufficiently minimized, process 700 generates another weight set by adjusting the values of the previously selected weight set. The amount of adjustment may be dependent upon cost value calculated at step 735. Weight values may be adjusted greatly for higher cost values, and less for lower cost values. In some embodiments, weight adjustment is determined by calculating the gradient of each weight with respect to the input activation function of each neurons activation function within the DMLP network and the difference between expected and calculated values for each neuron determined using backpropagation. Then a ratio of the weight's gradient is subtracted from the current weight value. The ratio, which is the learning rate of the machine learning system, of the weight's gradient that is subtracted may vary depending on implementation and training needs. For implementations emphasizing speed of training over accuracy, high ratios above may be selected. For implementations emphasizing accuracy over speed, lower ratios may be selected. Some implementations may also incorporate adjustable learning ratios.

Once the adjusted weight set for applying to the next iteration of training data has been generated (at step 750), process 700 selects the adjusted weight set and the DMLP network graph, directed acyclic graph, and expected output for the next training data set. Process 700 returns to step 730 where it applies the selected weight set (now adjusted from the previous iteration at step 750) and the selected directed acyclic graph to the selected DMLP network graph.

Process 700 performs steps 730-755 until the cost function is minimized at step 740. In some cases, after process 700 iterates over all sets of training data, the result at step 740 may still be higher than desired. In such cases, process 700 performs steps 735-755 again over all the training data. For example, if process 700 were using one-hundred pieces of training data and after processing training data set one-hundred, the result at step 740 was still NO, process 700 would select the training data set one and reiterate through all one-hundred training data sets until the result at step 740 is YES.

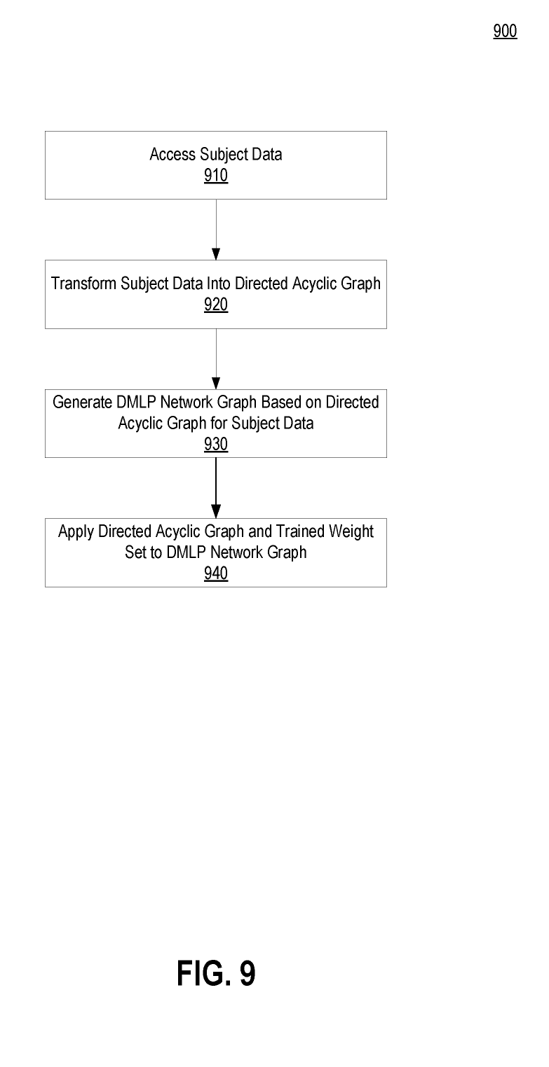

Once the result at step 740 is YES, process 700 selects the weight set of the current iteration as the trained weight set. The trained weight set may be used by the machine learning system to perform the task for which process 700 was training, as described below with respect to FIG. 9.

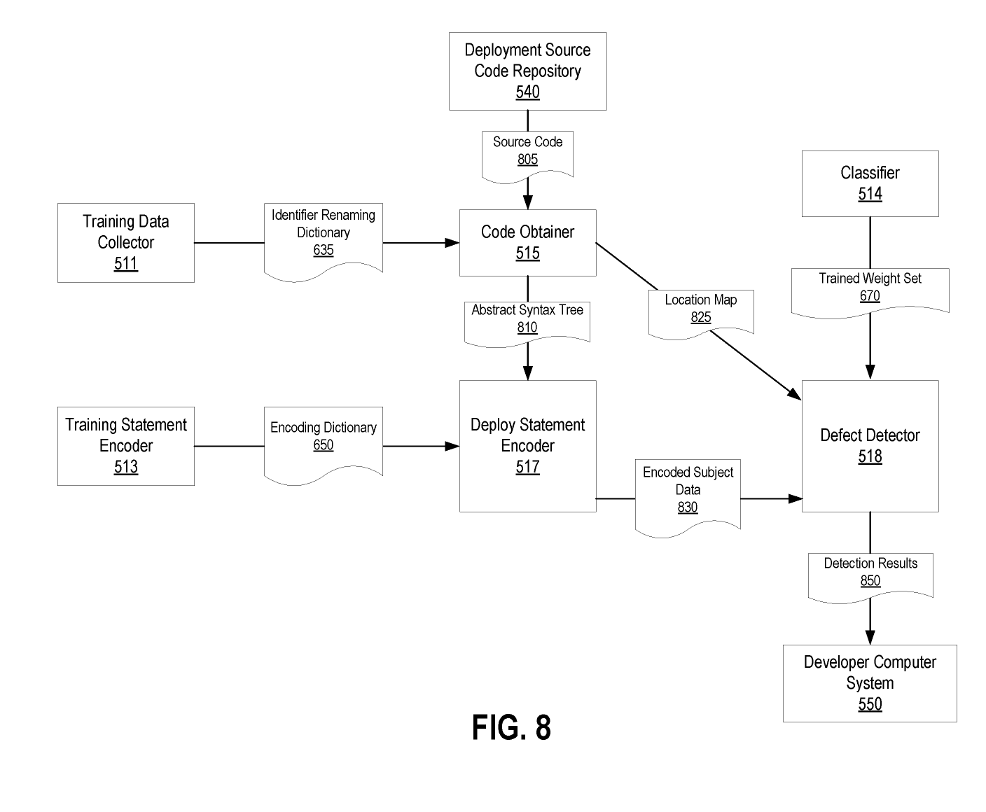

Returning to FIG. 5, according to some embodiments, source code analyzer 510 can also contain code obtainer 515, deploy statement encoder 517 and defect detector 518, which are modules and/or components for implementing a machine learning system employing DMLPs to identify defects in source code that is undergoing verification and validation. These modules or components of source code analyzer 510 can communicate data between each other according to known data communication techniques and, in some embodiments, can communicate with external computing systems such as deployment source code repository 540. FIG. 8 shows a data and process flow diagram depicting the data transferred to and from code obtainer 515, deploy statement encoder 517 and defect detector 518 according to some embodiments.

Source code analyzer 510 can include code obtainer 515. Code obtainer 515 performs operations to obtain source code analyzed by source code analyzer 510. As shown in FIG. 8, code obtainer 515 can obtain source code 805 from deployment source code repository 540. Source code 805 is source code that is part of a software development project for which verification and validation processes are being performed. Deployment source code repository 540 can provide source code 805 to code obtainer 515 via an API, file transfer protocol, or any other source code delivery mechanism known within the art. Code obtainer 515 can obtain source code 805 on a periodic basis, such as every week, or on an event basis, such as after a successful build of source code 805. In some embodiments, code obtainer 515 can interface with an integrated development environment executing on developer computer system 550 so developers can specify which source code files stored in deployment source code repository 540 code obtainer 515 gets.

According to some embodiments, code obtainer 515 transforms source code 805 into a directed acyclic graphical representation of the source code such as abstract syntax tree 810 in FIG. 8.

In some embodiments, code obtainer 515 can refactor and rename variables within abstract syntax tree 810 before providing it to deploy statement encoder 517. The refactor and rename process performed by code obtainer 515 is similar to the refactor and rename process described above with respect to training data collector 511, which is done to normalize pre-commit abstract syntax tree 625 and post-commit abstract syntax tree 630. According to some embodiments, code obtainer normalizes abstract syntax tree 810 using identifier renaming dictionary 635 produced by training data collector 511. Code obtainer 515 uses identifier renaming dictionary 635 so that abstract syntax tree 810 is normalized in the same manner as pre-commit abstract syntax tree 625 and post-commit abstract syntax tree 630.

Code obtainer 515 can also create location map 825. Location map 825 can be a data structure or file that maps abstract syntax tree 810 to locations within source code 805. Location map 825 can be a data structure implementing a dictionary, hashmap, or similar design pattern. As shown in FIG. 8, location map 825 can be used by defect detector 518. When defect detector 518 identifies a defect, it does so using a directed acyclic graphical representation of source code 805, such as abstract syntax tree 810. To link the abstraction of source code 805 back to a location within source code 805, defect detector 518 references location map 825 so that developers are aware of the location of the defect within source code 805 when developer computer system 550 receives detection results 850.

According to some embodiments, source code analyzer 510 can also include deploy statement encoder 517. Deploy statement encoder 117 performs operations to encode abstract syntax tree 810 so abstract syntax tree 810 is in a format that can be input to a DMLP network graph to identify defects. Deploy statement encoder 517 creates encoded subject data 830, an encoded representation of the abstract syntax tree 810, by replacing each statement in the abstract syntax tree 810 as defined in encoding dictionary 650. As explained above, training statement encoder 513 creates encoding dictionary 650 when source code analyzer 510 develops trained weight set 670.

Source code analyzer 510 can also include defect detector 518. Defect detector 518 uses trained weight set 670 as developed by classifier 514 to identify defects in source code 805 using a DMLP network graph. As shown in FIG. 8, defect detector 518 accesses trained weight set 670 from classifier 514 and receives encoded subject data 830 from deploy statement encoder 517. Defect detector 518 then generates a DMLP network graph based on the topology of encoded subject data 830 (which is an encoded version of abstract syntax tree 810 and maintains the same topology) and applies the trained weight set 670 to the generated DMLP network graph.

FIG. 9 illustrates a flowchart representing utilization process 900 for using a machine learning system using DMLPs to perform a task. According to some embodiments, one or more steps of process 900 can be performed by one or more components of source code analyzer 510. For example, some steps of process 700 may be performed by code obtainer 515 while other steps may be performed by defect detector 518. Moreover, process 900 below is described with respect to the components of source code analyzer 510 for ease of discussion. Process 900 may be implemented by other computer systems to train a machine learning system to use DMLPs to analyze inherently non-sequential data. That the description of FIG. 9 below refers to source code analyzer 510 or its components is not intended to limit the scope of the process to a particular application, machine, or apparatus

At step 910, process 900 accesses subject data. The subject data may be data that is inherently non-sequential or conditional in nature as opposed to sequential in nature. For example, subject data may be source code to be analyzed or maybe a decision tree reflecting a decision process over business domain or troubleshooting domain.

At step 920, process 900 transforms the subject data access at step 910 into a directed acyclic graphic. The directed acyclic graph may be a graphical representation of the conditions and branches of the subject data. For example, the directed acyclic graph may be an abstract syntax tree when the subject data is source code. Then, at step 930, process 900 generates a network graph based on the directed acyclic graft for the subject data that was created at step 920.

To determine to perform the task, at step 940, process 900 may apply a trained weight set to the DMLP network graph generated at step 930. The trained weight set may be a weight set determined by process 700 as described above with respect to FIG. 7. And, at step 940, process 900 may apply the directed acyclic graph to the generated DMLP network graph as input, getting values through the DMLP network graph to arrive at an output. In some embodiments, the output can include a classification for the input, such as a classification for source code (e.g., whether it contains a defect, if it contains a certain type of defect, or that the source code is for accomplishing a particular task or function).

Returning to FIG. 8, when analysis of the generated DMLP network graph determines that a defect is present, defect detector 518 appends the defect result to detection results 850, which is a file or data structure containing the defects for a data set (i.e., set of source code). Also, for each defect detected, defect detector 518 accesses location map 825 to lookup the location of the defect. The location of the defect is also stored to detection results 850, according to some embodiments.

Once defect detector 518 analyzes encoded subject data 830, detection results 850 are provided to developer computer system 550. Detection results 850 can be provided as a text file, XML file, serialized object, via a remote procedure call, or by any other method known in the art to communicate data between computing systems. In some embodiments, detection results 850 are provided as a user interface. For example, defect detector 518 can generate a user interface or a web page with contents of detection results 850, and developer computer system 550 can have a client program such as a web browser or client user interface application configured to display the results.

In some embodiments, detection results 850 are formatted to be consumed by an IDE plug-in residing on developer computer system 550. In such embodiments, the IDE executing on developer computer system 550 may highlight the detected defect within the source code editor of the IDE to notify the user of developer computer system 550 of the defect.

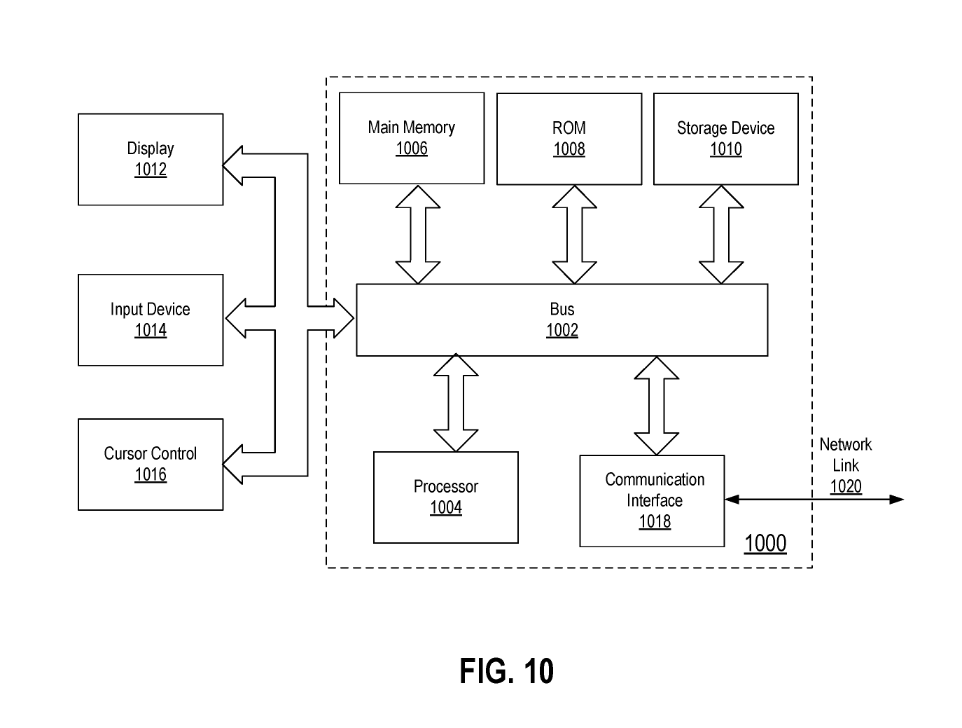

FIG. 10 is a block diagram of an exemplary computer system 1000, consistent with embodiments of the present disclosure. The components of system 500, such as source code analyzer 510, training source code repository 530, deployment source code repository 540, and developer computer system 550 can include an architecture based on, or similar to, that of computer system 1000.

As illustrated in FIG. 10, computer system 1000 includes a bus 1002 or other communication mechanism for communicating information, and hardware processor 1004 coupled with bus 1002 for processing information. Hardware processor 1004 can be, for example, a general purpose microprocessor. Computer system 1000 also includes a main memory 1006, such as a random access memory (RAM) or other dynamic storage device, coupled to bus 1002 for storing information and instructions to be executed by processor 1004. Main memory 1006 also can be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions. Computer system 1000 further includes a read only memory (ROM) 1008 or other static storage device coupled to bus 1002 for storing static information and instructions for processor 1004. A storage device 1010, such as a magnetic disk or optical disk, is provided and coupled to bus 1002 for storing information and instructions.

In some embodiments, computer system 1000 can be coupled via bus 1002 to display 1012, such as a cathode ray tube (CRT), liquid crystal display, or touch screen, for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. The input device typically has two degrees of freedom in two axes, a first axis (for example, x) and a second axis (for example, y), that allows the device to specify positions in a plane.

Computer system 1000 can implement disclosed embodiments using customized hard-wired logic, one or more ASICs or FPGAs, firmware and/or program logic which in combination with the computer system causes or programs computer system 1000 to be a special-purpose machine. According to some embodiments, the operations, functionalities, and techniques disclosed herein are performed by computer system 1000 in response to processor 1004 executing one or more sequences of one or more instructions contained in main memory 1006. Such instructions can be read into main memory 1006 from another storage medium, such as storage device 1010. Execution of the sequences of instructions contained in main memory 1006 causes processor 1004 to perform process steps consistent with disclosed embodiments. In some embodiments, hard-wired circuitry can be used in place of or in combination with software instructions.

The term “storage media” can refer, but is not limited, to any non-transitory media that stores data and/or instructions that cause a machine to operate in a specific fashion. Such storage media can comprise non-volatile media and/or volatile media. Non-volatile media includes, for example, optical or magnetic disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from, but can be used in conjunction with, transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infrared data communications.

Various forms of media can be involved in carrying one or more sequences of one or more instructions to processor 1004 for execution. For example, the instructions can initially be carried on a magnetic disk or solid state drive of a remote computer. The remote computer can load the instructions into its dynamic memory and send the instructions over a network line communication line using a modem, for example. A modem local to computer system 1000 can receive the data from the network communication line and can place the data on bus 1002. Bus 1002 carries the data to main memory 1006, from which processor 1004 retrieves and executes the instructions. The instructions received by main memory 1006 can optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network. For example, communication interface 1018 can be an integrated services digital network (ISDN) card, cable modem, satellite modem, or a modem to provide a data communication connection to a corresponding type of telephone line. As another example, communication interface 1018 can be a local area network (LAN) card to provide a data communication connection to a compatible LAN. Communication interface 1018 can also use wireless links. In any such implementation, communication interface 1018 sends and receives electrical, electromagnetic or optical signals that carry digital data streams representing various types of information.

Network link 1020 typically provides data communication through one or more networks to other data devices. For example, network link 1020 can provide a connection through local network 722 to other computing devices connected to local network 722 or to an external network, such as the Internet or other Wide Area Network. These networks use electrical, electromagnetic or optical signals that carry digital data streams. The signals through the various networks and the signals on network link 1020 and through communication interface 1018, which carry the digital data to and from computer system 1000, are example forms of transmission media. Computer system 1000 can send messages and receive data, including program code, through the network(s), network link 1020 and communication interface 1018. In the Internet example, a server (not shown) can transmit requested code for an application program through the Internet (or Wide Area Network) the local network, and communication interface 1018. The received code can be executed by processor 1004 as it is received, and/or stored in storage device 1010, or other non-volatile storage for later execution.

According to some embodiments, source code analyzer 510 and can be implemented using a quantum computing system. In general, a quantum computing system is one that makes use of quantum-mechanical phenomena to perform data operations. As opposed to traditional computers that are encoded using bits, quantum computers use qubits that represent a superposition of states. Computer system 1000, in quantum computing embodiments, can incorporate the same or similar components as a traditional computing system, but the implementation of the components may be different to accommodate storage and processing of qubits as opposed to bits. For example, quantum computing embodiments can include implementations of processor 1004, memory 1006, and bus 1002 specialized for qubits. However, while a quantum computing embodiment may provide processing efficiencies, the scope and spirit of the present disclosure is not fundamentally altered in quantum computing embodiments.

According to some embodiments, one or more components of source code analyzer 510 can be implemented using a cellular neural network (CNN). A CNN is an array of systems (cells) or coupled networks connected by local connections. In a typical embodiment, cells are arranged in two-dimensional grids where each cell has eight adjacent neighbors. Each cell has an input, a state, and an output, and it interacts directly with the cells within its neighborhood, which is defined as its radius. Like neurons in an artificial neural network, the state of each cell in a CNN depends on the input and output of its neighbors, and the initial state of the network. The connections between cells can be weighted, and varying the weights on the cells affects the output of the CNN. According to some embodiments, classifier 514 can be implemented as a CNN and the trained neural network 270 can include specific CNN architectures with weights that have been determined using the embodiments and techniques disclosed herein. In such embodiments, classifier 514, and the operations performed by it, by include one or more computing systems dedicated to forming the CNN and training trained neural network 270.

In the foregoing disclosure, embodiments have been described with reference to numerous specific details that can vary from implementation to implementation. Certain adaptations and modifications of the embodiments described herein can be made. Therefore, the above embodiments are considered to be illustrative and not restrictive.

Furthermore, throughout this disclosure, several embodiments were described as containing modules and/or components. In general, the word module or component, as used herein, refers to logic embodied in hardware or firmware, or to a collection of software instructions, possibly having entry and exit points, written in a programming language, such as, for example, C, C++, or C#, Java, or some other commonly used programming language. A software module may be compiled and linked into an executable program, installed in a dynamic link library, or may be written in an interpreted programming language such as, for example, BASIC, Perl, or Python. It will be appreciated that software modules can be callable from other modules or from themselves, and/or may be invoked in response to detected events or interrupts. Software modules can be stored in any type of computer-readable medium, such as a memory device (e.g., random access, flash memory, and the like), an optical medium (e.g., a CD, DVD, and the like), firmware (e.g., an EPROM), or any other storage medium. The software modules may be configured for execution by one or more processors in order to cause the disclosed computer systems to perform particular operations. It will be further appreciated that hardware modules can be comprised of connected logic units, such as gates and flip-flops, and/or can be comprised of programmable units, such as programmable gate arrays or processors. Generally, the modules described herein refer to logical modules that can be combined with other modules or divided into sub-modules despite their physical organization or storage.

Based on the foregoing, it should be appreciated that technologies for machine learning systems using dynamic multilayer perceptrons. Moreover, although the subject matter presented has been described in language specific to computer structural features, methodological acts, and computer readable media, it is to be understood that the appended claims are not necessarily limited to the described specific features, acts, or media. Rather, the specific features, acts, and mediums are disclosed as example implementations.

The subject matter described above is provided by way of illustration only and should not be construed as limiting. Furthermore, the claimed subject matter is not limited to implementations that solve any or all disadvantages noted in any part of this disclosure. Various modifications and changes may be made to the described subject matter described without following the example embodiments and applications illustrated and described, and without departing from the true spirit and scope of the disclosed embodiments.

What is claimed is:

1. A system comprising:
one or more processors; and,
one or more computer readable media storing instructions, that when executed by the one or more processors, cause the one or more processors to:
transform first source code into a first abstract syntax tree,
generate a first dynamic multilayer perceptron network graph based at least in part on the first abstract syntax tree,
apply a first weight set and the first abstract syntax tree to the first dynamic multilayer perceptron network graph to determine a first calculated output,
generate a second weight set by adjusting values of the first weight set based at least in part on a comparison of the first calculated output and a first expected output corresponding to the first source code,
transform second source code into a second abstract syntax tree,
generate a second dynamic multilayer perceptron network graph based at least in part on the second abstract syntax tree,
apply the second weight set and the second abstract syntax tree to the second dynamic multilayer perceptron network graph to determine a second calculated output, and
select the second weight set as a trained weight set based at least in part on a comparison of the second calculated output and a second expected output corresponding to the second source code.

2. The system of claim 1, wherein the instructions, when executed by the one or more processors, further cause the one or more processors to:
transform third source code into a third abstract syntax tree;
generate a third dynamic multilayer perceptron network graph based at least in part on the third abstract syntax tree; and
identify a classification for the third source code by applying the trained weight set and the third abstract syntax tree to the third dynamic multilayer perceptron network graph.

3. The system of claim 2 wherein the first dynamic multilayer perceptron network graph, the second dynamic multilayer perceptron network graph, and the third dynamic multilayer perceptron network graph comprise a plurality of nodes each comprising an input layer and a hidden layer, the plurality of nodes arranged in at least a first level and a second level.

4. The system of claim 3 wherein the first dynamic multilayer perceptron network graph, the second dynamic multilayer perceptron network graph, and the third dynamic multilayer perceptron network graph comprise:
input-to-hidden edges connecting the input layers of the plurality of nodes of the first level to the hidden layers of the plurality of nodes of the second level; and
hidden-to-hidden edges connecting the hidden layers of the plurality of nodes of the first level to the hidden layer of the plurality of nodes of the second level.

5. A method comprising:
accessing first training data comprising first input and first expected output;
accessing second training data comprising second input and second expected output;
transforming the first input into a first directed acyclic graph corresponding to the first dynamic multilayer perceptron network graph;
generating a first dynamic multilayer perceptron network graph based at least in part on the first input;
applying a first weight set and the first directed acyclic graph to the first dynamic multilayer perceptron network graph to determine a first calculated output;
calculating a first cost based at least in part on the first calculated output and the first expected output;
generating a second weight set by adjusting values of the first weight set based at least in part on the first cost;
transforming the second input into a second directed acyclic graph corresponding to the second dynamic multilayer perceptron network graph;
generating a second dynamic multilayer perceptron network graph based at least in part on the second input;
applying the second weight set and the second directed acyclic graph to the second dynamic multilayer perceptron network graph to determine a second calculated output;
calculating a second cost based at least in part on the second calculated output and the second expected output; and
selecting the second weight set as a trained weight set based at least in part on the second cost.

6. The method of claim 5 further comprising:
accessing subject data comprising subject input;
transforming the subject input into a subject directed acyclic graph;
generating a subject dynamic multilayer perceptron network graph based on the subject data; and
determining output for the subject data by applying the trained weight set and the subject directed acyclic graph to the subject dynamic multilayer perceptron network graph.

7. The method of claim 6 wherein the first dynamic multilayer perceptron network graph, the second dynamic multilayer perceptron network graph, and the subject dynamic multilayer perceptron network graph comprise a plurality of nodes each comprising an input layer and a hidden layer.

8. The method of claim 7 wherein the plurality of nodes are arranged in at least a first level and a second level.

9. The method of claim 8 wherein the first dynamic multilayer perceptron network graph, the second dynamic multilayer perceptron network graph, and the subject dynamic multilayer perceptron network graph comprise input-to-hidden edges connecting the input layers of the plurality of nodes of the first level to the hidden layers of the plurality of nodes of the second level.

10. The method of claim 9 wherein the first dynamic multilayer perceptron network graph, the second dynamic multilayer perceptron network graph, and the subject dynamic multilayer perceptron network graph comprise hidden-to-hidden edges connecting the hidden layers of the plurality of nodes of the first level to the hidden layer of the plurality of nodes of the second level.

11. The method of claim 10 wherein the first weight set, the second weight set, and the trained weight set comprise an input-to-hidden weight matrix and a hidden-to-hidden weight matrix.

12. The method of claim 11 wherein:
applying the first weight set comprises:
applying the input-to-hidden weight matrix of the first weight set to the input-to-hidden edges of the first dynamic multilayer perceptron network graph, and
applying the hidden-to-hidden weight matrix of the first weight set to the hidden-to-hidden edges of the second dynamic multilayer perceptron network graph;
applying the second weight set comprises:
applying the input-to-hidden weight matrix of the second weight set to the input-to-hidden edges of the second dynamic multilayer perceptron network graph, and
applying the hidden-to-hidden weight matrix of the second weight set to the hidden-to-hidden edges of the second dynamic multilayer perceptron network graph; and,
applying the subject weight set comprises:
applying the input-to-hidden weight matrix of the subject weight set to the input-to-hidden edges of the subject dynamic multilayer perceptron network graph, and
applying the hidden-to-hidden weight matrix of the subject weight set to the hidden-to-hidden edges of the subject dynamic multilayer perceptron network graph.

13. A system comprising:
one or more processors;
one or more computer readable media storing instructions that when executed cause the one or more processors to:
transform first input into a first directed acyclic graph;
generate a first dynamic multilayer perceptron network graph based at least in part on the first directed acyclic graph;
apply a first weight set and the first directed acyclic graph to the first dynamic multilayer perceptron network graph to determine a first calculated output;
generate a second weight set by adjusting values of the first weight set based at least in part on a comparison of the first calculated output and a first expected output corresponding to the first input;
transform second input into a second directed acyclic graph;
generate a second dynamic multilayer perceptron network graph based at least in part on the second directed acyclic graph;
apply the second weight set and the second directed acyclic graph to the second dynamic multilayer perceptron network graph to determine a second calculated output; and
select the second weight set as a trained weight set based at least in part on a comparison of the second calculated output and a second expected output corresponding with the second input.

14. The system of claim 13 wherein the instructions, when executed by the one or more processors, further cause the one or more processors to:
transform subject data into a directed acyclic graph;
generate a subject dynamic multilayer perceptron network graph based at least in part on the directed acyclic graph; and
determine output for the subject data by applying the trained weight set and the subject directed acyclic graph to the subject dynamic multilayer perceptron network graph.

15. The system of claim 14 wherein the first dynamic multilayer perceptron network graph, the second dynamic multilayer perceptron network graph, and the subject dynamic multilayer perceptron network graph comprise a plurality of nodes each comprising an input layer and a hidden layer.

16. The system of claim 15 wherein the plurality of nodes are arranged in at least a first level and a second level.

17. The system of claim 16 wherein the first dynamic multilayer perceptron network graph, the second dynamic multilayer perceptron network graph, and the subject dynamic multilayer perceptron network graph comprise input-to-hidden edges connecting the input layers of the plurality of nodes of the first level to the hidden layers of the plurality of nodes of the second level.

18. The system of claim 17 wherein the first dynamic multilayer perceptron network graph, the second dynamic multilayer perceptron network graph, and the subject dynamic multilayer perceptron network graph comprise hidden-to-hidden edges connecting the hidden layers of the plurality of nodes of the first level to the hidden layer of the plurality of nodes of the second level.

19. The system of claim 18 wherein the first weight set, the second weight set, and the trained weight set comprise an input-to-hidden weight matrix and a hidden-to-hidden weight matrix.

20. The system of claim 19 wherein:
applying the first weight set comprises:
applying the input-to-hidden weight matrix of the first weight set to the input-to-hidden edges of the first dynamic multilayer perceptron network graph, and
applying the hidden-to-hidden weight matrix of the first weight set to the hidden-to-hidden edges of the second dynamic multilayer perceptron network graph;
applying the second weight set comprises:
applying the input-to-hidden weight matrix of the second weight set to the input-to-hidden edges of the second dynamic multilayer perceptron network graph, and
applying the hidden-to-hidden weight matrix of the second weight set to the hidden-to-hidden edges of the second dynamic multilayer perceptron network graph; and,
applying the subject weight set comprises:
applying the input-to-hidden weight matrix of the subject weight set to the input-to-hidden edges of the subject dynamic multilayer perceptron network graph, and
applying the hidden-to-hidden weight matrix of the subject weight set to the hidden-to-hidden edges of the subject dynamic multilayer perceptron network graph.
